(19) United States
(12) Patent Application Publication
(10) Pub. No.: US 2020/0349643 A1
(43) Pub. Date: Nov. 5, 2020

(54) SYSTEM AND METHOD FOR FINANCING A PROPERTY PURCHASE

(71) Applicant: Stoa USA, Inc, North Miami Beach, FL (US)

(72) Inventor: Or AGASSI, Tel Aviv (IL)

(73) Assignee: Stoa USA, Inc, North Miami Beach, FL (US)

(21) Appl. No.: 16/864,568

(22) Filed: May 1, 2020

Related U.S. Application Data
(60) Provisional application No. 62/841,441, filed on May 1, 2019.

(51) Int. Cl. G06Q 40/02; G06Q 40/06; G06Q 50/16

(52) U.S. Cl. CPC G06Q 40/025; G06Q 50/167; G06Q 40/06

(57) ABSTRACT

A system and method for financing a property purchase are provided. A method includes receiving a financing request to finance a real-estate property; generating a first dataset including property-condition-related information; generating a second dataset including property-financial-related information; analyzing the information in the first dataset and the second dataset to determine eligibility of the received financing request; determining whether to grant or deny the received financing request based on the analysis; and sending either an approval or a denial.

### CROSS-REFERENCE TO RELATED APPLICATIONS

This application claims the benefit of U.S. Provisional Application No. 62/841,441 filed on May 1, 2019, the contents of which are hereby incorporated by reference.

### TECHNICAL FIELD

The present disclosure relates generally to the field of real estate assessment tools and, more specifically, to systems and methods for automatically providing loans for real estate transactions via the internet.

### BACKGROUND

The process of purchasing real estate, whether for residence, commercial purposes, or speculation, may involve one or more payments. As the payments required in a real estate transaction may require large sums, typically more than an investor or resident might have available, a third-party lender may be necessary to provide the required funds. Financing for real-estate transactions is an established practice, and many banks, mortgage brokers, and other lenders have processes in place to evaluate potential borrowers. However, these established practices include certain inefficiencies.

The process of applying for financing for a property purchase may be time-consuming, both for the lender and for the borrower. As a financing application may require extensive screenings, background checks, and meetings between borrowers and lenders, the financing process may require weeks, months, or years of attention before the desired financing can be secured. This delay may be unacceptable for certain borrowers who wish to take advantage of time-limited investment opportunities, such as by renovating and re-selling real-estate. Further, these delays may burden borrowers and lenders alike, with each seeking to finish the application process, either with an approval or a denial, as quickly as possible.

The inefficiencies of the lending process are further compounded by the number of potential parties and the complexity of the transactions. As multiple borrowers may seek financing at the same time, and as multiple lenders may be available, the process of reaching an agreement may require the additional time investment required to properly pair borrowers and lenders. This “shopping” time further reduces the lender's ability to meet with potential borrowers, reduces the borrower's opportunities for time-limited profit, and reduces the seller's ability to finish the sale quickly.

It would, therefore, be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for financing a property purchase. The method comprises: receiving a financing request to finance a real-estate property; generating a first dataset including property-condition-related information; generating a second dataset including property-financial-related information; analyzing the information in the first dataset and the second dataset to determine eligibility of the received financing request; determining whether to grant or deny the received financing request based on the analysis; and sending either an approval or a denial.

Certain embodiments disclosed herein also include a non-transitory computer readable medium having stored thereon instructions for causing a processing circuitry to execute a process, the process comprising: receiving a financing request to finance a real-estate property; generating a first dataset including property-condition-related information; generating a second dataset including property-financial-related information; analyzing the information in the first dataset and the second dataset to determine eligibility of the received financing request; determining whether to grant or deny the received financing request based on the analysis; and sending either an approval or a denial.

Certain embodiments disclosed herein also include a system for financing a property purchase. The system comprises: a processing circuitry, and a memory, the memory containing instructions that, when executed by the processing circuitry, configure the system to: receive a financing request to finance a real-estate property; generate a first dataset including property-condition-related information; generate a second dataset including property-financial-related information; analyze the information in the first dataset and the second dataset to determine eligibility of the received financing request; determine whether to grant or deny the received financing request based on the analysis; and send either an approval or a denial.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of an automated property financing system, according to an embodiment.

FIG. 2 is a flowchart describing a method for financing a property over the web, according to an embodiment.

FIG. 3 is a schematic diagram of a system for financing a property purchase, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for financing a property purchase. The system and method disclosed may be further applicable to securing financing for various types of tangible assets, such as cars, jewelry, art, and the like. Current financing methods include inherent inefficiency. As real-estate purchases may be time-sensitive, delays in the financing process may prevent the buyer and the seller from reaching an agreement which benefits both parties. To streamline the financing process, the following embodiments are disclosed.

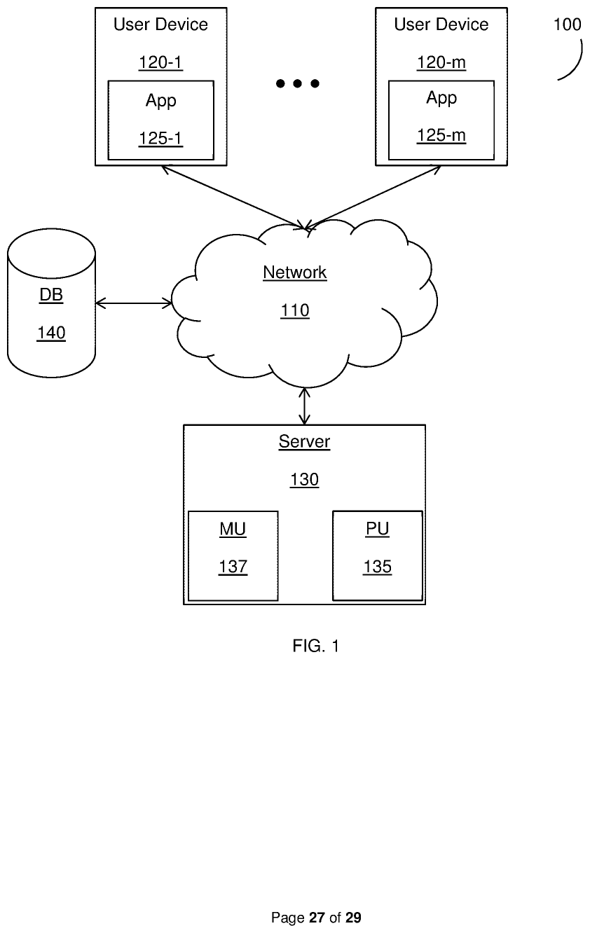

FIG. 1 is an example schematic diagram 100 of an automated property financing system, according to an embodiment. The schematic diagram 100 of the system includes a network 110 and multiple user devices, 120-1 through 120-m, each containing an application, 125-1 through 125-m. Further, the schematic diagram 100 of the system includes a database 140 and a server 130, the server containing a memory unit 137 and a processing unit 135. In the embodiment depicted, the user devices, 120-1 through 120-m, the database 140, and the server 130 are all connected to the network 110.

A network 110 is used to communicate between different parts of the system. The network 110 may be the Internet, the world-wide-web (WWW), a local area network (LAN), a wide area network (WAN), a metro area network (MAN), and other networks capable of enabling communication between the elements of the system. The network 110 may be a full-physical network, wherein all the included components are implemented as physical devices, a virtual network, wherein the included components are simulated or otherwise virtualized, or a hybrid physical-virtual network including some physical and some virtual components. The network 110 may be configured to accept wired connections, wireless connections, or both wired and wireless connections. Further, the network may be configured to encrypt data, both at rest and in motion, and to allow the transmission and receipt of encrypted, partially-encrypted, and unencrypted data.

One or more user devices 120-1 through 120-m (collectively referred to as user devices 120 or a user device 120) are further connected to the network 110. A user device 120 may be, for example, a personal computer (PC), a personal digital assistant (PDA), a mobile phone, a smart phone, a tablet computer, an electronic wearable device (e.g., glasses, a watch, etc.), a smart television, or another kind of wired or mobile appliance equipped with browsing, viewing, capturing, storing, listening, filtering, and managing capabilities enabled as further discussed herein below.

The user device or user devices, 120, may connect with the network 110 via wired means, including Universal Serial Bus (USB), Ethernet, and other, like, wired connections, wireless means, including Wi-Fi, Bluetooth®, Long-Term Evolution (LTE), and other, like wireless means, as well as any combination of wired and wireless connections. Further, the connection between a user device 120 and the network 110 may be encrypted, partially-encrypted, or unencrypted. The connection between the user devices 120 and the network 110 may be configured to allow the user devices 120 to send data to the network 110, to receive data from the network 110, or to simultaneously send and receive data.

Each user device 120 may further include a software application (app) 125 installed thereon. The application 125 may be downloaded from an application repository, such as the App Store®, Google Play®, or any other repositories hosting software applications. The application 125 may be pre-installed in the user device 120. In an embodiment, the application 125 is a web-browser. The application 125 may be designed to implement a loan-review process. In an embodiment, the application 125 may be configured to create a connection, via the network 110, between the user device 120 and one or more servers 130. In a further embodiment, the application 125 may be configured to generate a connection between multiple user devices 120 via the network 110.

A server 130 is communicatively connected to the user devices 120 and can communicate therewith using the application 125 via the network 110.

It should be noted that only one user device 120 and one application 125 are discussed herein merely for the sake of simplicity. However, the embodiments disclosed herein are applicable to a plurality of user devices 120 that can communicate with the server 130 via the network 110. Further, in an embodiment, the network 110 may be configured to enable connections between multiple user devices 120 without the inclusion of a server 130, and between multiple servers 130 without the inclusion of a user device 120. The embodiments described may be implemented without any loss of generality or departure from the scope of the disclosed.

Also communicatively connected to the network 110 is a database 140 that stores metadata related to certain property transactions, data extracted from regulatory data sources and/or tax authorities, geographic information systems (GISs), and more. In the embodiment illustrated in FIG. 1, the server 130 communicates with the database 140 through the network 110. The database 140 may be implemented as one or more computers, servers, data storage repositories, cloud servers, or other data storage media. The one or more components of the database 140 may be co-located, or may be dispersed across multiple locations. The database 140 may be connected to the network 110. The connection between the database 140 and the network 110 may be encrypted, partially-encrypted, or unencrypted. The connection between the database 140 and the network 110 may be configured to allow the database 140 to send data to the network 110, to allow the database 140 to receive data from the network 110, or to allow the database 140 to simultaneously send and receive data. In an embodiment, multiple databases 140 may be employed.

In an embodiment, the server 130 is configured to receive a request to finance a certain property over the network 110 from a user device 120 such as, for example, the user device 120-1 operated by an applicant applying for a loan. The property may be, for example, a house, villa, condo, commercial real-estate, multi-family complex, apartment, lot, office tower, and the like. The request may include one or more formal information categories, one or more open response fields, or a combination of formal information categories and open response fields. The formal information categories included in the request may specify certain information types, certain value formats, and the like. In an example, formal information categories may include requested loan amounts, for which a numerical response may be expected, applicant name fields, for which string or text responses may be expected, and confirmation or approval fields, for which multiple choice or checkbox responses may be expected. The open response fields included in the request may allow an applicant to include information in the request which is not specified in the formal information categories described above. The open response fields may include character, word, or paragraph limits.

The request includes the loan amount requested and metadata associated with the property. The metadata may include, for example, location coordinates, characteristics, such as sizes, rooms, and facilities, and the like. The loan amount data included in the request may include loan information such as, as examples and without limitation, the loan term requested, the interest rate requested, any specific loan terms or stipulations requested by the borrower, other, like, information, and any combination thereof. The loan amount, and any other related information, as described above, may be included in the request manually, by user's input, by suggestion in consideration of other entered loan information, other like loans, and other potentially relevant factors, or may be pre-specified, allowing a user to request a loan with predetermined amounts, terms, and rates. In an embodiment, loan amounts, terms, rates, and other, related factors may be displayed as suggestions or automatically included in the request and may be generated based on information relating to the property, prevalent local and national loan terms, analyses of related economic factors, and other, like, information. In a further embodiment, the request may include a set of loan requests, which may include user-supplied and automatically-generated loan information, allowing a lender to receive a combination of terms which may suit the needs of both the lender and the borrower.

Further, the metadata associated with the property may include information relating to factors including, without limitation, the year of construction, a list of any constructed or planned renovations or expansions, other, like, information, and any combination thereof. Metadata associated with the property may be collected from user input, analysis of public records such as deeds and zoning permits, and other, like, sources. The metadata associated with the property may include labels indicating the source of the information included, the date on which the information was most recently updated, a confidence rating assigned to property metadata with uncertain or contested values, such as in the case of historic buildings, indicators of whether complete property records exist, other, like, information, and any combination thereof.

The metadata may further include, for example, regulatory information, for example, certain laws that apply to the property, such as rent stabilization. Regulatory information may be collected from federal, local, municipal, and other government sources. Regulatory information may include land use ordinances, zoning codes, other, like, regulations, and various combinations thereof. In an embodiment, regulatory information may include private, enforceable restrictions such as, as examples, and without limitation, covenants, easements, homeowners' association restrictions, and the like. Where regulatory information includes private, enforceable restrictions, the private restrictions may be gathered from sources including user input, analysis of deeds, wills, and titles, other, like, sources, and any combination thereof.

The request further includes development information as well as other indications of costs of anticipated improvements. Development information may include the prospective borrower's planned renovations, cost estimates, estimates concerning increases in property value, other, like, information, and any combination thereof. Where an applicant would not be, or is not, the absolute owner of the property, development information may further include planned renovations, and the associated costs and property value increases, planned by other owners or tenants of the property. Development information may be collected from user input, filed building permits and zoning allowances, and other, like, sources.

The indications of costs of anticipated improvements may include information such as, as examples and without limitation, the applicant's planned renovations, cost estimates for the planned renovations, property value improvements due to the planned renovations, and other, like, information. Further, the borrower's anticipated costs may also include costs necessary to secure ownership of the property and to perfect title. These non-renovation costs may include tax liens, mechanic's liens, judgements against the borrower, mortgages from previous owners, and other, like costs. The non-renovation costs may further include prospective costs such as the borrower's estimated mortgage or property-related loan payments, forward-looking property tax estimates, homeowners' association fees or other, similar fees, rent, if applicable, and other, like, costs. The indications of anticipated costs may be gathered from user input, from assessment of property tax records, deeds, and other, public documents, and from any combination thereof.

The request further includes metadata associated with the applicant such as, for example, name, job title, information related to the applicant's credit score, past transaction history, financial data, and the like. Applicant metadata may be gathered by user input, as supplied by the applicant or borrower, from public records searches, from background and other searches requiring the borrower's consent, from other, like, sources, and from any combination thereof. In an embodiment, applicant metadata may be anonymized, de-identified, or otherwise obfuscated to conceal an applicant's identity, such that the request includes only information necessary to evaluate the loan application.

The request may further include certified documents associated with the purchase of the property, data from a title company, appraisal data, inspection, credit card and/or other payment method details, and the like. Property purchase information, as included in the request, may be gathered from user input, public records searches, entry by paid appraisers or investigators, from other, like, sources, and from any combination thereof.

The request is analyzed by the server 130. The analysis may include one or more machine-learning techniques. The analysis may further include matching the request to similar requests which exist in the database 140. Based on the analysis, the server 130 may be configured to determine whether the applicant associated with the user device 120 has a credit standing which meets a given threshold value. The credit standing is determined for the specific applicant submitting the request, based on credit information received in the request, credit information gathered independently when the request is received, or based on a combination of provided and gathered information.

The server 130 may be configured to automatically analyze all requests received, to automatically analyze or set aside requests containing specific information, to set some or all requests aside for human analysis or supervision, or any combination thereof. In an embodiment, the analysis may further include machine learning techniques, such as supervised learning routines. In this embodiment, the server 130 may be trained to analyze requests and determine whether the information in the requests qualifies a credit standing which meets the threshold value.

The threshold value, against which the applicant's credit standing is compared, may be pre-set, determined automatically at the time the request is received, collected from a database or other repository of credit or risk information, gathered by other means, or collected using a method including more than one of the above-mentioned processes. Where the threshold value is pre-set, the value may be determined and entered by the lender or the lender's agent and may be updated from time to time, as may be necessary. Where the threshold value is gathered from automatic sources such as predefined lender-specific algorithms or from databases or repositories of risk or credit information, the analysis may include an administrative override, allowing the lender or lender's agent to modify or override the automatic threshold value determination. In an embodiment, the applicant's calculated credit standing, as described below, as well as the determined threshold value, may be displayed to the applicant by email, SMS, in-app notifications, or by other, like, means.

In an embodiment, the credit standing may be determined based on metadata related to the applicant collected by the server 130, as received in the request described above. The metadata may be collected implicitly by tracking the applicant's activities, such as through the user device 120, or by capturing and analyzing inputs from one or more sensors included in the user device 120, such as, for example, a camera, a voice recorder, and the like. Such metadata may include, for example, certain characteristics related to the applicant using the user device 120. The characteristics may include, as examples and without limitation, facial or voice reactions, mouse scrolling, touch screen gestures and keyboard typing, personal information from social networks, online comments, and the way the applicant interacts with online games. According to another embodiment, the metadata may be collected explicitly from the applicant's responses to questions sent to the user device 120. According to another embodiment, the metadata related to the applicant may be extracted from the database 140 in cases where the applicant has already submitted a request for financing a property.

In addition, the server 130 is configured to collect data related to the applicant from one or more data sources over the network 110 such as, for example, credit bureaus, state, local, and federal sources, other, like, sources, and any combination thereof. The collected data is analyzed by the server 130 to determine the credit standing of the applicant. The data collected from one or more network sources may include, as examples and without limitation, credit ratings, judgments against the applicant, the applicant's property tax records, the applicant's property history, including rentals and sales, other, like, information, and any combination thereof. In an embodiment, the data related to the applicant, collected from network sources as described above, may be stored, sent, and processed as encrypted data, partially-encrypted data, or unencrypted data. Further, the data related to the applicant, collected from network sources, may be anonymized, de-identified, or otherwise obfuscated to conceal the potential applicant's personal information from one or more lenders.

According to another embodiment, the server 130 is further configured to collect metadata related to the property. The metadata related to the property may include, as examples, cost, address, and/or location coordinates, landscape details, details of past ownerships, regulatory information, collateral data, and the like. As an example, if the property price is too low and the repair cost is too high, a higher predetermined threshold value may be set because of the risk associated with financing the property. The cost and loan term may be mapped to a threshold value based on a predefined mapping table. The metadata can be collected from public sources, such as multiple listing services systems (MLSs), censuses, municipal data sources, weather databases, news websites, and the like.

In one embodiment, the property, or similar or equivalent properties, may be designated in a mapping table with a respective threshold. The predefined mapping table may be generated once or regularly, and may be created by the lender or lender's agent or generated by an independent party, such as a bank or a professional appraiser, and may be accessed through an online portal or website. Metadata related to the property may be collected from the applicant's request, from automatic extraction from public records such as zoning tables, chains of title, tax records, deeds and wills, and the like, from private sources such as independent appraisers or property inspectors, from other, like, sources, and from any combination thereof. In an embodiment, the threshold value may be determined based only on property-related metadata.

In one embodiment, as part of the analysis, a weighted value is generated for each element of the collected applicant-related data and each one of the property-related data elements. In an embodiment, a weighted decision algorithm is utilized to compute the applicant's credit standing. Accordingly, each parameter collected with respect to the applicant's credit may be scored and assigned a virtual weighting value indicating the importance of the respective parameter to the credit standing. Further, the values of the parameters may be scored according to a parameter scoring scheme, allowing for the determination of credit standing based on weighted value analysis.

Parameter scoring may be based on the contents of the data included in the received request, data gathered from other sources, or any combination thereof. Parameter scoring may be automatically performed by the server 130 upon receiving the request, may be manually completed by the lender or the lender's agent, or a third party, or may be completed by a combination of manual and automatic means. Parameter scoring may be completed on an absolute basis, where collected data is assigned a score, based on its contents, using a set of predefined rules, tables, and the like. Further, parameter scoring may be completed on a relative basis, whereby data collected may be assigned a score based on comparison of the collected data with the contents of other financing requests or applications, scoring the application's data as a reflection of its values relative to other received values. In an embodiment, parameter scoring may include a combination of absolute and relative scoring, and various scoring systems may be applied for varying data types, data fields, and the like.

In an example, parameter scoring may be achieved with respect to a received request by evaluating the contents of the received request and any non-request information collected, as described above. Where an absolute scoring process dictates that any application specifying a certain property zip code receives a score of five for the property zip code field, the score may be applied to the application. Similarly, where a relative scoring system indicates, after comparison, that the applicant's income falls within the top twenty percent of applicants, the score associated with the income field may be eight-tenths, or another value specified to correspond with the indicated percentile.

Weighted values may be predetermined and applied uniformly across multiple financing application evaluations. In an embodiment, weighted values may be dynamic and may be updated or modified by the lender or the lender's agent, by a separate weighting-evaluation algorithm, or both. As an example, a score corresponding to data collected from a credit bureau indicating the applicant's financial status may receive a higher virtual weighting value than a score attributed to the applicant's comments in a social network website and, therefore, will be more significant in the determination of the applicant's credit. In one embodiment, the weighted decision algorithm computes the credit standing, for example, as the weighted average of the scored parameters.

The computation of weighted values of the collected elements may be adjusted based on the total amount of data collected. For example, if only a few elements are collected, then each such collected element will be more significant in the credit determination. Furthermore, the generation of values may be adjusted based on the type of property. In one embodiment, the values are computed using rules stored in the database 140. Each such rule may set a value for one or more pieces of data collected for the credit standing analysis. Examples for such rules are provided below.

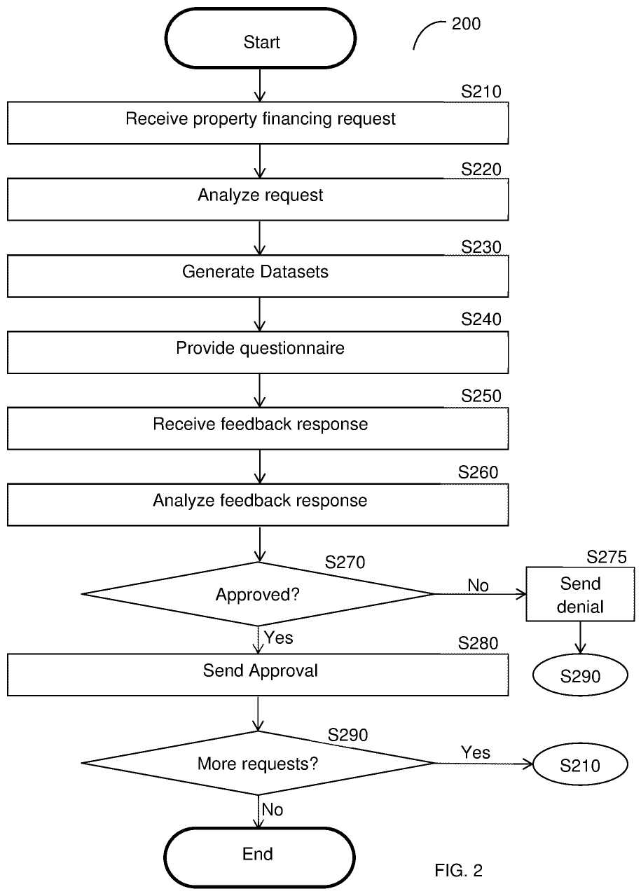

In an embodiment, the server 130 may be configured to generate a first dataset associated with the applicant and a second dataset associated with the property. The first and second datasets are described in greater detail with respect to S230 of FIG. 2, below.

According to a further embodiment, a questionnaire is generated and provided to the applicant based on the results of the analysis, discussed above. The questionnaire is customized for the applicant based on of the determinations made by the server 130. The questionnaire comprises a plurality of questions that are used for determining information related to the applicant, the property, and the financing requested, for purposes including loan risk mitigation. The questions may be drawn from the database 140 based on a predefined set of rules. Feedback received responsive to the questionnaire may be used to determine whether the request is approved. In an embodiment, the questionnaire may be time limited.

The questionnaire may include one or more questions related to the applicant, the property, and the loan requested. The questions may be drawn from the database 140 based on a predefined set of rules. The predefined set of rules, used to selectively incorporate questions from the database 140 into the questionnaire, may be configured to populate the questionnaire with questions related to the applicant's credit standing, necessary questions not answered in the request, questions regarding unclear or ambiguous information provided in the request, other, like, questions, and any combination thereof.

The questions included in the questionnaire may include answer fields, in which an applicant can input responses to the questions contained in the questionnaire. The answer fields may include fields into which an applicant may enter data in forms such as, as examples and without limitation, multiple choice, true or false, long answer, short answer, and open-ended. Further, the answer fields may be configured to accept entries of certain data types such as, as examples and without limitation, strings, text, characters, binary (true/false), and other, like, answer types. Where answer types such as short answer, long answer, and open-ended are included in the questionnaire, the corresponding answer fields may be restricted to a predefined number of characters, words, sentences, or paragraphs, or by other limitations.

Thereafter, a determination as to whether the request is approved is made by the server 130 based on the analysis and the feedback received in response to the questionnaire. Where the determination is based only on the analysis, the determination may consider whether the applicant's aggregate weighted parameter scores, as discussed above, are sufficient to meet the threshold value. Where the determination is based only on answers to questions included in the questionnaire, the data received may be assessed in a manner similar or identical to the analysis described above, or may be assessed in consideration of factors included which require manual review. Where the determination is based on both the analysis and the answers to the questionnaire, approval or denial may be based on a hybrid metric system. A hybrid metric may be generated based on the applicant's determined credit standing and the contents of the received applicant feedback response. The hybrid metric system may establish certain disqualifying or automatically-qualifying data or responses, and may grant or deny applications based on whether the data or responses are included in the application or questionnaire. In an embodiment, the hybrid metric system may be configured to grant or deny requests including specific terms, keywords, values, or other pre-defined elements. In addition, the hybrid metric system may be configured to grant or deny applications, having strong requests and weak questionnaire responses, or vice-versa, on the basis of the relative strength or weakness of the information drawn from one source as compared with the other.

Where the request is approved, a guarantee to finance the property is sent to the applicant. The guarantee may be sent to the user device 120 belonging to or operated by the applicant. Such a guarantee may include, but is not limited to, a binding promise to execute an actual transfer of funds, a certified voucher, credit card information, and the like. The approval guarantee may further include a summary of the terms of the financing agreement. In embodiment, the approval may be made subject to one or more terms, such as, for example, arranging for an appraisal report, an inspection of the property, and the like. In an embodiment, the approval notification may include a feature allowing the applicant to accept the financing offer based on the terms given. The guarantee may be sent to the applicant as an email, printed letter, SMS, notification in an application, or by other means.

All data relevant to the request and the determination of whether to approve the request is saved in the database 140. The database 140 may further include one or more rules used for determination of the virtual value of the collected elements. Further, the data warehouse may be optimized to provide improved data retrieval speeds, stored data integrity, and the like. Data stored in the database 140, and data-in-motion, whether sent to or received from the database 140, may be encrypted, unencrypted, or partially-encrypted.

Where the request is denied, a notification may be provided to the user device 120. The notification may include cause for denial, as well as an option for refiling. The option for refiling may be time-based. Alternatively, the notification may include a counteroffer with one or more different terms. The notification may be provided to the user as an email, printed letter, SMS, or in-application notification, or by other means.

FIG. 2 is an example flowchart 200 describing a method for financing a property over the web, according to an embodiment.

At S210, a request to finance a real-estate property is received. The request to finance the real estate property may be received from an applicant. The request includes metadata associated with the applicant and the property, as well as information relating to the loan requested. As described with respect to FIG. 1, above, the request may include formal information categories, for which certain response types may be expected, as well as open-ended response fields. As an example, the request may include details related to the applicant, regulatory data related to the property, the purchase price, development costs, title approval, appraisal report and payment method. The received request may be analyzed at S220 to determine the applicant's credit standing, which may be subsequently applied at S270 to a determination of whether to grant or deny the request.

At S220, the request received at S210 is analyzed. The analysis at S220 may include analysis of the financing request received at S210 to determine the applicant's credit standing. The analysis at S220 may further include generation of the applicant's weighted credit standing based on the applicant's credit standing. The determination of the applicant's weighted credit standing may be further compared with a predetermined threshold value to determine eligibility of the financing request. The applicant's determined weighted credit standing, as well as the result of the comparison with the appropriate threshold value, may be subsequently applied at S270 to a determination of whether to grant or deny the request. The analysis at S220, as well as the generation of the relevant applicant's credit standing and weighted credit standing and the respective threshold value, is further described with respect to FIG. 1, above.

The weighted credit standing is a credit standing calculated based on weighted scores for the various factors considered. Factors may be given higher or lower weighting values based on each factor's importance in the credit standing determination. As an example, a score assigned to the applicant's current income may be weighted more heavily, while a score assigned to an applicant's age may be weighted less heavily

At S230, a first dataset associated with the applicant and a second dataset associated with the property are generated. The first dataset may include property-condition-related information. The included property-condition-related information may be gathered from the information included in the request received at S210, from information gathered automatically, such as by analysis of keyword-matched public records searches, from input by the lender or lender's agent, from other, like, sources, and any combination thereof. Information may be added to the first dataset automatically by means including, without limitation, automatic extraction from webpages, extraction from public records, where the public records may be searched based on the applicant's information, property information, or other search terms, or from other, like, sources. Property-condition-related information, as included in the first dataset, may include property locations, lot numbers, years of construction, zoning codes, current and previous owners and tenants, relevant deeds, permits, and other public records, other, like, information, and any combination thereof. Property-condition-related information, as included in the first dataset, may further include at least a required repair report.

The condition-related information further includes a home inspection application program configured to provide at least a report on required repairs. An example for such a report, and a process for generating such a report, is disclosed in co-pending U.S. patent application Ser. No. 16/863,569, titled “SYSTEM AND METHOD FOR DETERMINING A PROPERTY REMODELING PLAN USING MACHINE VISION”, assigned to the common assignee, which is hereby incorporated by reference.

The second dataset may include property-financial-related information. The included property-financial-related information may be gathered from information included in the request received at S210, from information gathered automatically, such as by analysis of keyword-matched public records searches, from input by the lender or lender's agent, from other, like, sources, and any combination thereof. Information may be added to the second dataset automatically by means including, without limitation, automatic extraction from webpages, extraction from public records, where the public records may be searched based on the applicant's information, property information, or other search terms, or from other, like, sources. Property-financial-related information included in the second dataset may include property values, financing terms, purchase dates and other dates, and other, like, information.

At S240, based on the generated datasets, a questionnaire is generated and provided to the user device. The questionnaire is generated as described in greater detail with respect to FIG. 1, above. The questionnaire may include prompts requesting information concerning the financing desired, the property in question, and the applicant. The questionnaire may be a standard-form questionnaire applicable to all applicants, may be a custom questionnaire drafted for one particular applicant, or may be a standard-form questionnaire modified for one particular applicant. The questionnaire may be generated manually, automatically, or in a supervised-automatic fashion, including by a machine learning system. In an embodiment, the questionnaire may be populated with questions drawn from a data source, such as the database, 140, of FIG. 1, above.

At S250, an applicant feedback response to the questionnaire is collected. The response to the questionnaire collected at S250 may be collected from the user device. Where no response is collected, or where an incomplete response is collected, S250 may include sending the applicant a reminder notification. The reminder notification may be sent to the user by email, SMS, postal mail, in-application notification, or by other means.

At S260, the applicant feedback response collected at S250 is analyzed to further determine eligibility of the received financing request. The analysis of the feedback is described in greater detail with respect to FIG. 1, above. The analysis, at S260, may include analysis of the first and second datasets generated at S230, from which the questionnaire provided at S240 is generated, to determine eligibility of the received financing request based on the contents of the datasets. The analysis, at S260, of the feedback may be applied to the determination of whether to grant the request, as at S270.

At S270, it is determined whether the request for a loan is approved based on the credit standing determination at S220, the questionnaire responses received at S250, or both. If the request is approved, execution continues with S280; otherwise, execution continues with S275. The determination of whether to grant or deny the received financing request may be based on the analysis of the first and second datasets at S260. The determination of whether to approve the request is described in detail with respect to FIG. 1, above. Further, the determination of whether to grant or deny the received financing request may include the generation and configuration of hybrid metrics, including such factors as the applicant's determined credit standing and the received applicant feedback response, as is described with respect to FIG. 1, above. In addition,

At S275, a denial notification is generated and sent to the user device 120, and execution continues with S290. The denial notification may be sent to the user as an in-application notification displayed on the user device 120, as an email, SMS message, posted letter, or by another form of communication. The denial notification may include information relating to the reason for which the request was denied, suggestions for how an applicant might improve their request, and other, like, information. In an embodiment, the denial notification may include suggestions for other loan terms for which approval may be granted. In a further embodiment, the denial notification may include suggestions of other properties for which a loan with similar terms may be approved.

At S280, an approval notification is generated and sent. The approval notification may be sent to the user by in-application notification displayed on the user device, 120, of FIG. 1, above, or as an email, SMS message, posted letter, or other form of communication. The approval notification may include a guarantee to finance the property transaction. In addition, the approval information may include information regarding the next steps necessary for a borrower to receive loan funds, as well as other, like, information. In an embodiment, the approval notification may include a field, form, or other means by which the borrower may indicate acceptance of the financing agreement with the terms stated. Where a borrower's acceptance request is included in the approval notification, a completed borrower's indication may be returned for storage and recordkeeping. In an embodiment, the approval notification may include a separate document allowing the borrower to retain a copy of the loan terms for record-keeping.

At S290, it is checked whether additional requests have been received and, if so, execution continues with S220; otherwise, execution terminates. Additional requests may be received from additional users, from the user whose request was evaluated previously, and from any combination thereof.

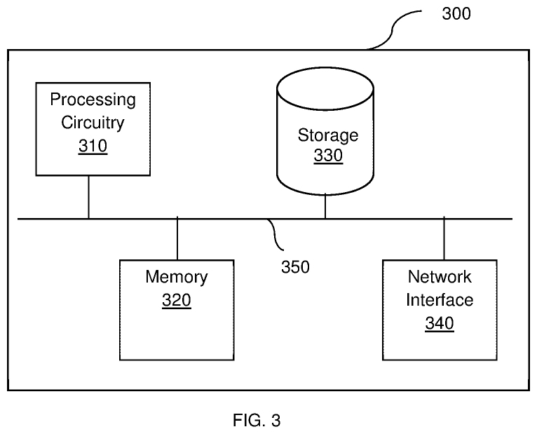

FIG. 3 is an example schematic diagram of a system 300 for financing a property purchase, according to an embodiment. The system 300 includes a processing circuitry 310 coupled to a memory 320, a storage 330, and a network interface 340. In an embodiment, the components of the system 300 may be communicatively connected via a bus 350.

The processing circuitry 310 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 320 may be volatile (e.g., RAM, etc.), non-volatile (e.g., ROM, flash memory, etc.), or a combination thereof. In one configuration, computer readable instructions to implement one or more embodiments disclosed herein may be stored in the storage 330.

In another embodiment, the memory 320 may be configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 310, cause the processing circuitry 310 to perform the various processes described herein.

The storage 330 may be magnetic storage, optical storage, and the like, and may be realized, for example, as flash memory or another memory technology, CD-ROM, Digital Versatile Disks (DVDs), or any other medium which can be used to store the desired information.

The network interface 340 allows the system 300 to communicate with the network, 110, of FIG. 1, above, for the purpose of, for example, receiving data, sending data, and the like.

It should be understood that the embodiments described herein are not limited to the specific architecture illustrated in FIG. 3, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for financing a real-estate property purchase, comprising:
receiving a financing request to finance a real-estate property;
generating a first dataset including property-condition-related information;
generating a second dataset including property-financial-related information;
analyzing the information in the first dataset and the second dataset to determine eligibility of the received financing request;
determining whether to grant or deny the received financing request based on the analysis; and
sending either an approval or a denial.

2. The method of claim 1, further comprising:
collecting at least one applicant feedback response for at least one questionnaire; and
analyzing the at least one applicant feedback response to further determine eligibility of the received financing request.

3. The method of claim 2, further comprising:
analyzing the received financing request to determine an applicant's credit standing; and
generating an aggregate weighted credit standing based on the applicant's credit standing.

4. The method of claim 3, further comprising:
comparing the aggregate weighted credit standing with a threshold value to further determine eligibility of the received financing request.

5. The method of claim 4, wherein determining whether to grant or deny the received financing request further includes:
generating a hybrid metric based on the applicant's determined credit standing and the contents of the received at least one applicant feedback response.

6. The method of claim 5, wherein determining whether to grant or deny the received financing request further includes:
configuring the hybrid metric to grant or deny requests including specific terms, keywords, values, or other pre-defined elements.

7. The method of claim 1, wherein the first dataset includes at least a required repair report.

8. The method of claim 7, wherein the first dataset further includes property locations, lot numbers, years of construction, zoning codes, current and previous owners, tenants, relevant deeds, and permits.

9. The method of claim 1, wherein the second dataset includes property values, financing terms, and purchase dates.

10. A non-transitory computer readable medium having stored thereon instructions for causing a processing circuitry to execute a process, the process comprising:
receiving a financing request to finance a real-estate property;
generating a first dataset including property-condition-related information;
generating a second dataset including property-financial-related information;
analyzing the information in the first dataset and the second dataset to determine eligibility of the received financing request;
determining whether to grant or deny the received financing request based on the analysis; and
sending either an approval or a denial.

11. A system for financing a property purchase, comprising:
a processing circuitry; and
a memory, the memory containing instructions that, when executed by the processing circuitry, configure the system to:
receive a financing request to finance a real-estate property;
generate a first dataset including property-condition-related information;
generate a second dataset including property-financial-related information;
analyze the information in the first dataset and the second dataset to determine eligibility of the received financing request;
determine whether to grant or deny the received financing request based on the analysis; and
send either an approval or a denial.

12. The system of claim 11, wherein the system is further configured to:
collect at least one applicant feedback response for at least one questionnaire; and
analyze the at least one applicant feedback response to further determine eligibility of the received financing request.

13. The system of claim 12, wherein the system is further configured to:
analyze the received financing request to determine an applicant's credit standing; and
generate an aggregate weighted credit standing based on the applicant's credit standing.

14. The system of claim 13, wherein the system is further configured to:
compare the aggregate weighted credit standing with a threshold value to further determine eligibility of the received financing request.

15. The method of claim 14, wherein the system is further configured to:
generate a hybrid metric based on the applicant's determined credit standing and the contents of the received at least one applicant feedback response.

16. The system of claim 15, wherein the system is further configured to:
configure the hybrid metric to grant or deny requests including specific terms, keywords, values, or other pre-defined elements.

17. The system of claim 11, wherein the first dataset includes at least a required repair report.

18. The system of claim 17, wherein the first dataset further includes property locations, lot numbers, years of construction, zoning codes, current and previous owners, tenants, relevant deeds, and permits.

19. The system of claim 11, wherein the second dataset includes property values, financing terms, and purchase dates.
